(19) United States
(12) Patent Application Publication
(10) Pub. No.: US 2003/0145648 A1
(43) Pub. Date: Aug. 7, 2003

(54) Device for metering the injection quantity of injection systems and method for producition thereof

(76) Inventors: Joachim Unger, Gerlingen (DE); Ralf Bindel, Winterbach (DE); Ralf Haas, Illingen (DE); Dirk Wolf, Renningen (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/204,282

(22) PCT Filed: Dec. 13, 2001
(86) PCT No.: PCT/DE01/04695

(30) Foreign Application Priority Data
Dec. 20, 2000 (DE) 1 00 63 713.2

(51) Int. Cl. G01M 19/00

(52) U.S. Cl. 73/118.1

(57) ABSTRACT

A device (10) serves to measure the injection quantity of injection systems (16), in particular for motor vehicles, and in particular in production testing. The device (10) includes a measuring chamber (14), and a coupling device by which at least one injection system (16) can be coupled to the measuring chamber (14) in pressureproof fashion. The device (10) further includes a piston (26), which is held displaceably in a guide device (18) and regionally defines the measuring chamber (14). Finally, a sensor (50) is also provided, which upon an injection by the injection system (16) detects a displacement of the piston (26). To increase the measurement precision, it is proposed that the piston (26) be at least essentially closed and be hollow in its interior.

### PRIOR ART

The present invention relates first to a device for measuring the injection quantity of injection systems, in particular for motor vehicles and in particular in production testing, having a measuring chamber, a coupling device by which at least one injection system can be coupled in pressureproof fashion to the measuring chamber, a piston, which is held displaceably in a guide device and regionally defines the measuring chamber, and a sensor, which upon an injection by the injection system detects a displacement of the piston.

Such a device is known on the market and is called an EMI (for injection quantity indicator). It includes a cylinder in which a piston is guided. The wall of the measuring chamber is formed at least regionally by the piston. The measuring chamber also has an opening, to which an injection nozzle of an injection system, such as an injector, can be connected in pressureproof fashion. If the injection nozzle injects fuel or a special testing fluid into the measuring chamber, the piston moves, which is detected by a travel sensor. From the travel of the piston, a conclusion can be drawn as to the change in volume of the measuring chamber and from that as to the injected quantity of fuel or testing fluid.

The known injection quantity indicator has various disadvantages, however. Especially in the event of short but forceful injection pulses, vibration of the piston occurs, which fades only relatively slowly and therefore makes measurement of injections that occur in rapid succession difficult or even impossible. Moreover, upon a motion of the piston in the cylinder, friction occurs at the walls touching one another, so that among other circumstances, the piston motion does not always represent the actual volume injected. Moreover, the piston-cylinder combination is also subject to wear, and thus the outcome of measurement and the measurement precision can both vary over the life of the device.

The present invention therefore has the object of refining a device of the type defined at the outset in such a way that it can function with greater accuracy even over a long service life.

This object is attained, in a device of the type defined at the outset, in that the piston is at least essentially closed and is hollow in its interior.

According to the invention, it has been recognized that particularly in the event of pulselike injections, the piston is exposed to severe loads, as a result of which it can become deformed. Such deformations can cause canting of the piston in the guide opening of the guide device, and this is at least partly responsible for the problems addressed above.

Because of the closed design according to the invention, the stability of the piston is increased considerably. Because of the hollow design, the weight is changed only insignificantly. The greater rigidity of the piston according to the invention decreases the deformation in the region of the measuring device, and as a result the overall outcome of measurement becomes more precise, and the wear between the piston jacket and the guide wall of the guide opening in the cylinder is reduced.

Advantageous refinements of the invention are defined by dependent claims.

In one refinement, the piston includes a base body open on one side and a cap that closes the opening, which cap is preferably pressed onto and/or welded to the base body. A piston constructed in this way can be produced relatively inexpensively and yet in stable form.

If the piston, at least on its side oriented toward the measuring chamber, includes a material that is heat resistant and has poor heat conduction, then the deformations upon injection of a typically heated fluid (approximately 80° C.) are reduced further.

In a refinement of this device of the invention, it is proposed that the piston includes a caplike top attachment of a material that is heat resistant and has poor heat conduction. A top attachment of this kind acts as a kind of “heat shield”, which protects the structure of the piston from the effects of the temperature of the heated testing fluid.

Alternatively or in addition to the above-proposed special design, the stability of the piston can also be improved by means of a particular selection of material. It is accordingly proposed according to the invention that the piston at least regionally includes an aluminum alloy and/or a titanium alloy. It is especially preferred that the piston at least regionally includes an alloy of the AlMgSi1 or TiAl6V4 type.

The improvement in measurement precision can also be attained by providing that at least the jacket face of the piston, oriented toward the guide device, is treated in such a way that it is low-friction and/or low-wear, in particular by means of a hard coating or by the application of a C-coating. With such surface treatments or surface coatings, surfaces can be achieved which on the one hand are very smooth and therefore have only slight friction and on the other are very hard and thus are subject to only slight wear.

The structural provisions for increasing the measurement precision and extending the service life of the device of the invention can also be performed for the guide device. For instance, it is proposed that the guide device at least regionally includes an aluminum alloy, a steel alloy, or a titanium alloy, in particular AlMgSi1, 31CrMoV9, or TiAl6V4.

Moreover, at least the guide device can be treated at least regionally in such a way that it is low-friction and/or low-wear, in particular by means of a hard coating and/or a plasma nitriding.

According to the invention, pairings of material which are especially compatible with one another with a view to low friction and low wear are proposed. It is thus proposed that the piston and the guide device include an aluminum alloy, in particular AlMgSi1. Alternatively, the piston can include a titanium alloy, in particular TiAl6V4, and the guide device can include a steel alloy, in particular 31CrMoV9, or also a titanium alloy, in particular TiAl6V4.

The present invention also relates to a method for producing a device of the type. The best measurement results, because of low friction and low wear, are attained with the device whenever the piston is produced by turning, grinding, subfinishing and hard coating or C-coating, and the guide device is produced by turning, grinding, hard coating or plasma nitriding and honing.

Below, one exemplary embodiment of the invention will be explained in detail in conjunction with the accompanying drawing. The sole drawing figure is a longitudinal section through a device for measuring the injection nozzles, in particular for motor vehicles.

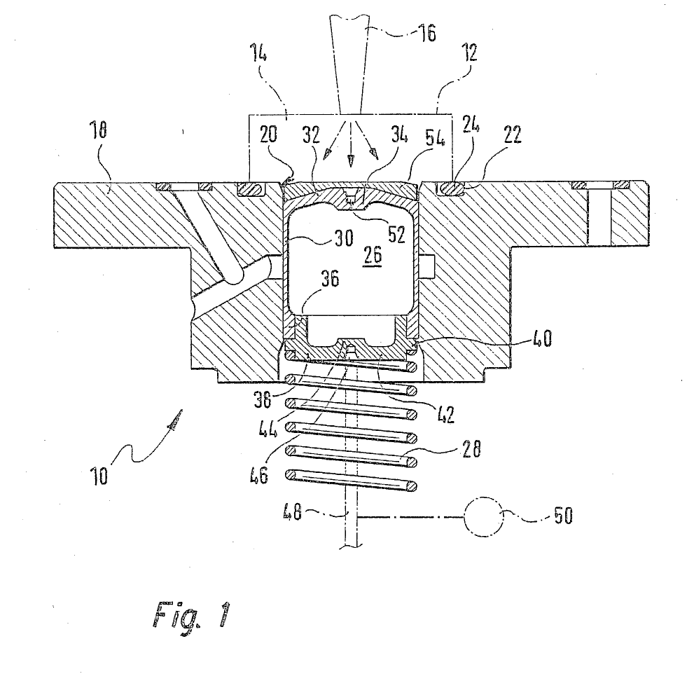

In FIG. 1, this device is identified by reference numeral 10. It includes a measuring chamber 14, which is formed in a housing 12 and to which an injection nozzle 16 is coupled in pressureproof fashion. The housing 12, measuring chamber 14 and injection nozzle 16 are represented only schematically in the drawing, by dot-dashed lines.

On its lower side, in terms of FIG. 1, the measuring chamber 14 is defined by a guide cylinder 18, which in plan view, that is, seen from above in FIG. 1, is a circular-cylindrical turned part. The cylinder 18 has a central guide bore 20. Coaxially to the guide bore 20, an annular groove 22 is made in the top side of the cylinder 18, and a sealing ring 24 is placed in it. By means of this sealing ring 24, the housing 12 is joined to the cylinder 18 in pressureproof fashion.

A piston 26 is held displaceably in the guide bore 20 of the cylinder 18. Toward the top, that is, toward the measuring chamber 14, the piston 26 is prestressed by a spring 28. The piston 26 includes first a cylindrical base body 30, whose end wall 32 bulges slightly outward, and which in its middle has a material thickening 34. The base body 30 is open at the bottom and has an inward-pointing annular collar 36 on its lower edge.

A likewise cylindrical cap 38 is pressed onto the underside of the base body 30; the outer diameter of the cap is approximately equivalent to the inner diameter of the annular collar 36, and on its outer jacket face, in the vicinity of its lower end in terms of FIG. 1, this cap has an annular collar 40. Alternatively or in addition, the cap 38 can also be welded. This welding acts as a stop for the cap 38 on the lower edge of the base body 30. The end wall 42 of the cap 38 is embodied as essentially flat, and in its middle it has a thickening 44 oriented toward the base body 30.

In the region of the thickening 44, a blind bore 46 is made in the outside of the end wall 42 of the cap 38. A piston rod 48, shown only schematically, is secured in the blind bore via a thread, and its motion is picked up by a travel sensor 50. A central blind bore 52 is also present in the outside of the end wall 32 of the base body 30, in the region of the material thickening 34, and serves to secure a caplike top attachment 54, which is made from a heat-resistant material with poor heat conduction. The top attachment 54, whose function is essentially that of a heat shield, is essentially circular, and it rests flatly with its underside on the end wall 32 of the base body 30. The top side of the top attachment 54 is essentially parallel to the top side of the cylinder 38, but in its radial peripheral region it is parallel to the top side of the end wall 32 of the base body 30.

As can be seen from FIG. 1, the piston 26 is in general a cylindrical hollow body. The base body 30 of the piston 26 is made from the aluminum alloy AlMgSi1. It is produced by first being turned; the surface is then ground and subfinished, and finally a hard coating is applied. The cylinder 18 is likewise made from the same aluminum alloy, but in its production after turning it is first ground and then a hard coating is also applied. Finally, the guide bore 20 of the cylinder 18 is also honed.

By this combination in terms of material and machining, the friction between the piston 26 and the cylinder 18 becomes minimal. Moreover, the individual elements are also embodied in an extremely wear resistance way. This increases the precision of measurement of the injection quantity and lengthens the service life over which precise measurement is possible. Since the piston 26 is a closed hollow body, it has very high stiffness with low mass. As a result, the vibration of the piston 26 after an injection pulse is reduced, and deformations that can cause increased friction between the piston 26 and the guide bore 20 in the cylinder 18 are reduced.

It can be seen from the drawing that in the circumferential wall of the guide bore, there is a groove (not identified by reference numeral), which performs the following task: First, by means of it, a testing fluid that is injected by the nozzle 16 and flows downward in the form of leakage between the cylinder 18 and the piston 26 can be carried away. Second, it prevents gas from entering the measuring chamber 14. This is necessary, since during operation, a gas pressure of up to 100 bar can prevail below the piston 26, or in other words on the side of the piston 26 remote from the measuring chamber 14. If gas were to reach the measuring chamber 14, it could cause vibration of the measuring piston 26 and could thus make the results of measurement wrong.

Moreover, the groove acts to secure against damage to the device (10) in the event that between injections, not enough testing fluid is removed from the measuring chamber 14 through the nozzle 16, or in other words if the measuring chamber is not “emptied” enough. In the event of such a slight emptying, which also results in “overfilling” of the measuring chamber, the piston 26 drops down so far that the testing fluid can flow into this groove and then into a testing fluid drain. This averts an excessively sharp pressure rise in the measuring chamber 14.

It should also be noted that as an alternative to the exemplary embodiment shown, the piston 26 can also be produced from a titanium alloy, in particular TiAl6V4, and instead of a hard coating, the jacket face of the base body 30 can have a carbon coating. In that case, the cylinder 18 should be produced from a steel alloy, above all 31CrMoV9, or a titanium alloy, such as TiAl6V4, and the guide bore 20 should be either hard-coated or plasma-nitrided. This combination of materials likewise leads to the desired improvement. Finally, it should be noted that the heat shield 54 can also be glued to the end wall 32 of the base body 30 of the piston 26. It should also be noted that the closed design of the piston 26 not only has advantages in operation of the device 10 but already enhances the stability of the piston 26 during production, so that the jacket face of the base body 30 can be machined better, or in other words with greater accuracy.

1. A device for measuring the injection quantity of injection systems (16), in particular for motor vehicles and in particular in production testing, having a measuring chamber (14), a coupling device by which at least one injection system (16) can be coupled in pressureproof fashion to the measuring chamber (14), a piston (26), which is held displaceably in a guide device (18) and regionally defines the measuring chamber (14), and a sensor (50), which upon an injection by the injection system (16) detects a displacement of the piston (26), characterized in that the piston (26) is at least essentially closed and is hollow in its interior.

2. The device of claim 1, characterized in that the piston (26) includes a base body (30) open on one side and a cap (38) that closes the opening, which cap is preferably pressed onto and/or welded to the base body (30).

3. The device of one of claims 1 or 2, characterized in that the piston (26), at least on its side oriented toward the measuring chamber (14), includes a material that is heat resistant and has poor heat conduction.

4. The device of claim 3, characterized in that the piston (26) includes a caplike top attachment (54) of a material that is heat resistant and has poor heat conduction.

5. A device for measuring the injection quantity of injection systems (16), in particular for motor vehicles and in particular in production testing, having a measuring chamber (14), a coupling device by which at least one injection system (16) can be coupled in pressureproof fashion to the measuring chamber (14), a piston (26), which is held displaceably in a guide device (18) and regionally defines the measuring chamber (14), and a sensor (50), which upon an injection by the injection system (16) detects a displacement of the piston (26), characterized in that the piston (26) at least regionally includes an aluminum alloy and/or a titanium alloy.

6. The device of one of the foregoing claims, characterized in that the piston (26) at least regionally includes an alloy of the AlMgSi1 or TiAl6V4 type.

7. The device of one of the foregoing claims, characterized in that at least the jacket face of the piston (26), oriented toward the guide device (18), is treated in such a way that it is low-friction and/or low-wear, in particular by means of a hard coating or by the application of a C-coating.

8. The device of one of the foregoing claims, characterized in that the guide device (18) at least regionally includes an aluminum alloy, a steel alloy, or a titanium alloy, in particular AlMgSi1, 31CrMoV9, or TiAl6V4.

9. The device of claim 8, characterized in that at least the guide device (18) is treated at least regionally in such a way that it is low-friction and/or low-wear, in particular by means of a hard coating and/or a plasma nitriding.

10. The device of one of the foregoing claims, characterized in that the piston (26) and the guide device (18) include an aluminum alloy, in particular AlMgSi1, or the piston includes a titanium alloy, in particular TiAl6V4, and the guide device includes a steel alloy, in particular 31CrMoV9, or a titanium alloy, in particular TiAl6V4.

11. A method for producing a device of one of the foregoing claims, characterized in that the piston (26) is produced by turning, grinding, subfinishing and hard coating or C-coating, and the guide device (18) is produced by turning, grinding, hard coating or plasma nitriding and honing.
